(19) United States
(12) Patent Application Publication
(10) Pub. No.: US 2015/0046642 A1
(43) Pub. Date: Feb. 12, 2015

(54) MEMORY COMMAND SCHEDULER AND MEMORY COMMAND SCHEDULING METHOD

(71) Applicant: SAMSUNG ELECTRONICS CO., LTD., Suwon-si (KR)

(72) Inventors: Tae-young LEE, Suwon-si (KR); Sung-gu LEE, Pohang-si (KR); Cheul-hee HAHM, Seongnam-si (KR)

(73) Assignee: SAMSUNG ELECTRONICS CO., LTD., Suwon-si (KR)

(21) Appl. No.: 14/453,994

(22) Filed: Aug. 7, 2014

(30) Foreign Application Priority Data
Aug. 7, 2013 (KR) 10-2013-0093565

(51) Int. Cl. G06F 3/06

(52) U.S. Cl. CPC G06F 3/0659; G06F 3/0604; G06F 3/0671; G06F 2003/0697
USPC 711/105; 711/167

(57) ABSTRACT

A memory command scheduler is provided. The memory command scheduler includes a scheduler queue receiving first and second requests for a memory access from external devices and storing the first and second requests therein; and a controller generating a command of the second request after a preset number of clock cycles from a current clock cycle and transferring the generated command to a memory, if generation of a command of the first request is possible in the current clock cycle and generation of the command of the second request is possible after the preset number of clock cycles from the current clock cycle.

### CROSS-REFERENCE TO RELATED APPLICATIONS

This application claims priority from Korean Patent Application No. 10-2013-0093565, filed on Aug. 7, 2013, in the Korean Intellectual Property Office, the disclosure of which is incorporated herein by reference in its entirety.

### BACKGROUND

1. Field

Apparatuses and methods consistent with exemplary embodiments relate to a memory command scheduler and a memory command scheduling method, and more particularly, to a memory command scheduler and a memory command scheduling method that uses a future prediction technology.

2. Description of the Related Art

A DDRx (Double Data Rate) SDRAM (Synchronous Dynamic Random Access Memory) device (here, x indicates an integer of two or more and depends on a type of SDRAM device) is operated by receiving a data read command and a data write command for a requested address position and an address from a memory controller and returning requested data through data bus, if the data read command or the data write command are present. If a command for a DDRx memory is present, the memory controller should satisfy a condition for a delay between specific types of commands.

The DDRx SDRAM device stores data in a single transistor plus capacitor (IT/IC) memory cell. The IT/IC memory cell should be periodically refreshed by reading the data from and rewriting the data to respective memory cells in order to protect integrity of the data. The memory cells are arranged in a rectangular pattern and are accessed using addresses of a row and a column. For an efficient operation, when a row address is given together with an activate (A) command, data of a row having the row address are read by a row buffer. In addition, when a column address is given together with a read (R) command, data bits of a row buffer at a position represented by the column address are transmitted from the DDRx SDRAM device to a requesting device after a delay corresponding to a few clock cycles (that may be preset by specification data on each type of DDRx SDRAMs). After data of one row are read, the column address may also be provided together with a write (W) command. In this case, after the delay corresponding to a few clock cycles, data sent from an external device are stored in a position represented by the column address within the row buffer. When the data of the row buffer are not requested any more, a precharge (P) command may be given to the DDRx SDRAM device. When this command is received, a bit line voltage is precharged such that the data of the row buffer are returned to and stored in a memory array of the DDRx SDRAM device, and the row buffer is in an empty state.

The memory array of the DDRx SDRAM device may be configured to have a preset number of banks. For example, in a DDR4 SDRAM device having 16 banks, 16 banks may be present and data of 16 rows (data on each of the banks) may be stored in 16 individual row buffers. A state in which a row buffer for any bank is filled is called an open state. A state in which the row buffer for any bank is not filled is called a closed state. Since a plurality of banks are used, each of activate (A), read (R), write (W), and precharge (P) commands sent to the DDRx SDRAM device should include bank addresses so that a corresponding operation is performed on only data on a bank corresponding to an address (However, optionally, the P command may be performed on all banks. In this case, all of the banks should be closed). The DDR4 includes a concept for a bank group. Usually, the bank is divided into several bank groups. In the DDR4, two or four bank groups are used. A continuous operation such as a read command or an activate command for memory data cells in different bank groups is generally performed slightly more rapidly as compared with a continuous operation in the same bank group.

When an external device is to read data from the DDRx SDRAM device, the external device sends a memory read request to a memory controller. In this case, the memory controller issues a series of appropriate commands for the DDRx SDRAM and informs, when the data are prepared, the external device that the data have been prepared. When the bank is in an opened state and an opened row address coincides with a row address of requested data (e.g., if the bank and the row address are matched to each other and the requested data is already present in a row buffer for the bank), only one read command is requested. However, when the bank is in a closed state, the activate command should be preferentially sent together with a row address for fetching row data corresponding to a row buffer before the read command is performed. When the bank is in the opened state, but the opened row address does not coincide with the row address of the requested data, the bank should be preferentially closed together with the precharge command before the requested row may be retrieved together with the activate command. In addition, the read command follows the activate command. Therefore, in this case, a command sequence is a sequence of precharge-activate-read (P-A-R).

When the external device is to write data in the DDRx SDRAM device, the external device sends a memory write request to the memory controller. In this case, the memory controller issues a series of appropriate commands for the DDRx SDRAM and informs the external device when it sends data to be written in the memory. When the bank is in an opened state and an opened row address coincides with a row address of requested data (e.g., if the bank and the row address are matched to each other and the requested data is already present in a row buffer for the bank), only one write command is requested. However, when the bank is in a closed state, the activate command should be preferentially sent together with a row address for fetching row data corresponding to a row buffer before the write command is performed. Therefore, a command sequence is a sequence of activate-write (A-W). When the bank is in the opened state, but the opened row address does not coincide with the row address of the requested data, the bank should be closed together with the precharge command before the requested row may be retrieved together with the activate command. In addition, the write command follows the activate command. Therefore, in this case, a command sequence is a sequence of precharge-activate-write (P-A-W).

Performance parameters used to evaluate performance of a memory system are a memory throughput and a latency. The memory throughput indicates number of bytes transmitted from or to the DDRx SDRAM device per second. These parameters determine a method by which a memory device may be efficiently used. When a data bus between the DDRx SDRAM device and the memory controller transmits or receives data for p % of a processing time, a final memory throughput will be a value obtained by multiplying a maximum bandwidth of a memory channel by p. The latency of the memory read request corresponds to a period from a time in which the request is provided to the memory controller to a time in which data on the request start to be transmitted to a requester. Likewise, the latency of the memory write request corresponds to a period from a time in which the request is transferred to the memory controller to a time in which data start to be transmitted from the memory controller to the requester. For example, average/maximum memory read/write latency times are measured and used.

In the related art, a hardware circuit called a memory access scheduler for sending a memory command to the DDRx SDRAM device has been suggested. This hardware circuit may be designed as a separate device connected to the memory controller, be included as a part of memory controller hardware in the memory controller hardware, or be designed so as to substitute for a part of the memory controller hardware. Memory read and write requests from the external device are buffered in one or more scheduler queue, and various heuristic technologies for determining scheduler entries to be executed in each clock cycle may be used. A simple rule of a scheduling technology is to process the respective memory read and write requests in an order in which the requests arrive. In this case, a memory command sequence that needs to be created with respect to the respective read and write requests depends on a state of an accessed memory bank. For this reason, a memory throughput decrease, a processing latency, or the like, may occur depending on an order in which memory requests arrive from an external device. Here, a state of the memory bank depends on a memory command created in the past.

In order to improve memory performance, a reordering scheduler may be implemented. The reordering scheduler changes a processing order of the memory requests in the scheduler queue. One typical reordering scheduler is a first-ready first-come-first-served (FR-FCFS) scheduler. The FR-FCFS scheduler searches a first entry that may send one of (P, A, R, and W) memory commands without violating a DDRx timing specification for a current clock cycle while starting a search from the oldest entry in a scheduler queue and sends a corresponding command to the DDRx SDRAM. It has been known that the FR-FCFS scheduler may improve throughput performance by about 93% as compared with a first-in order scheduler. However, in this scheme, memory requests are not processed in an order in which they arrive. Therefore, a memory request starvation problem that requests from some devices are delayed for a significantly long time may occur. This depends on judgment that a memory command scheduler first processes a processing request of another device to increase a memory throughput.

Therefore, a plurality of improved reordering scheduling methods capable of accomplishing a high memory throughput while solving the memory request starvation problem have been suggested through papers and patents. However, these existing methods have a problem that all usable information on entries present in a scheduler queue in a scheduling heuristic are not used. As a result, performance has not been satisfactorily improved.

Another problem is that a memory request having a high priority is not handled well. Two kinds of methods for processing a memory request having a priority especially higher than those of other memory requests have been suggested. One is a method of using a heuristic technology other than the FR-FCFS, and the other is to allocate a limited amount of credit or token to priority requests and then preferentially process a memory request having the above-mentioned credit as compared with other requests when a predetermined condition is satisfied.

Analyzing the t above-described methods, it has been well known that the FR-FCFS method shows the highest memory processing level with respect to a general memory request pattern in a condition in which a traffic is high. However, when an alternative scheduling heuristic method for a request having a high priority is used, an entire memory throughput is sacrificed in order to decrease a latency time of the request having the high priority. In addition, an unacceptable excessive latency may occur with respect to a request having a non-high priority in a very high traffic condition. Likewise, a method based on a credit or a token for handling a request having a high priority also has a problem that an unacceptable excessive latency may occur with respect to a request having a non-high priority.

Therefore, an innovative memory command scheduling method that may maintain memory throughput performance and may not excessively increase latency times of other memory requests while preferentially processing a request having a high priority has been required.

### SUMMARY

Exemplary embodiments of the present disclosure overcome the above disadvantages and other disadvantages not described above. Also, the present disclosure is not required to overcome the disadvantages described above, and an exemplary embodiment of the present disclosure may not overcome any of the problems described above.

The present disclosure provides an efficient memory command scheduling method and structure using future prediction based on information present in a scheduler queue and an innovative memory command scheduler and memory command scheduling method capable of maintaining a memory throughput and decreasing memory latency while preferentially processing a request having a high priority.

According to an aspect of exemplary embodiments, there is provided a memory command scheduler including: a scheduler queue configured to receive first and second requests for a memory access from external devices and stores the first and second requests therein; and a controller configured to generate a command of the second request after a preset number of clock cycles from a current clock cycle and transfer the generated command to a memory, if generation of a command of the first request is possible in the current clock cycle and generation of the command of the second request is possible after the preset number of clock cycles from the current clock cycle.

The commands of the first and second requests may have the same memory bank and row address.

The controller may generate the command of the first request in the current clock cycle and transfer the generated command to the memory, if memory banks or row addresses of the commands of the first and second requests are different from each other.

The controller may generate a control command of a third request so as to be more preferential than the first and second requests and transfer the generated control command to the memory, if the third request for a memory access that is to be urgently executed in the current clock cycle is received and stored in the scheduler queue.

The controller may generate a precharge or activate command of the first request and transfer the generated precharge or activate command to the memory, if generation of a read or write command of the first request is not possible in the current clock cycle.

The read or write command may be transferred together with an address for the memory to the memory.

Memory command scheduling may be performed based on an order in which the requests are received.

The memory may be a double data rate (DDR) synchronous dynamic random access memory (SDRAM).

The memory command scheduler may further include a row buffer configured to store data on a preset bank and row address of the memory therein if an activate command of a request for a memory access from the external devices is present.

According to another aspect of exemplary embodiments, there is provided a memory command scheduling method including: receiving first and second requests for a memory access; storing the first and second requests in a scheduler queue; and generating a command of the second request after a preset number of clock cycles from a current clock cycle and transferring the generated command to a memory, if generation of a command of the first request is possible in the current clock cycle and generation of the command of the second request is possible after the preset number of clock cycles from the current clock cycle.

The commands of the first and second requests may have the same memory bank and row address.

The memory command scheduling method may further include generating the command of the first request in the current clock cycle and transferring the generated command to the memory, if memory banks or row addresses of the commands of the first and second requests are different from each other.

The memory command scheduling method may further include generating a control command of a third request so as to be more preferential than the first and second requests and transferring the generated control command to the memory, if the third request for a memory access that is to be urgently executed in the current clock cycle is received and stored in the scheduler queue.

The memory command scheduling method may further include generating a precharge or activate command of the first request and transferring the generated precharge or activate command to the memory, if generation of a read or write command of the first request is not possible in the current clock cycle.

The generated command may be transferred together with an address for the memory to the memory.

The memory command scheduling method may be performed based on an order in which the requests are received.

The memory may be a DDR SDRAM.

According to another aspect of exemplary embodiments, there is provided a memory command scheduling method including: receiving first to third requests for a memory access; storing the first to third requests in a scheduler queue; determining whether an urgent request is present in a current clock cycle; and generating a control command of the urgent request in the current clock cycle and transferring the generated control command to a memory, if it is determined that the urgent request is present in the current clock cycle.

The memory command scheduling method may further include generating a command of the second request after a preset number of clock cycles from the current clock cycle and transferring the generated command to the memory, if it is determined that the urgent request is not present in the current clock cycle, generation of a command of the first request is possible in the current clock cycle and generation of the command of the second request is possible after the preset number of clock cycles from the current clock cycle.

The memory command scheduling method may further include generating a command of the second request after a preset number of clock cycles from the current clock cycle and transferring the generated command to the memory, if it is determined that the urgent request is not present in the current clock cycle, generation of a read or write command of the first request is possible in the current clock cycle, generation of a precharge or activate command of the first request is possible in the current clock cycle, and the commands of the first and second requests have the same memory bank and row address.

The memory command scheduling method may further include generating a precharge or activate command of the first request in the current clock cycle and transferring the generated precharge or activate command to the memory, if it is determined that the urgent request is not present in the current clock cycle, generation of a read or write command of the first request is possible in the current clock cycle, generation of a precharge or activate command of the first request is possible in the current clock cycle, and memory banks or row addresses of the first and second requests are different from each other.

The memory command scheduling method may further include generating a read or write command of the first request in the current clock cycle and transferring the generated read or write command to the memory, if it is determined that the urgent request is not present in the current clock cycle, generation of the read or write command of the first request is possible in the current clock cycle, and generation of a command of the second request is not possible after a preset number of clock cycles from the current clock cycle.

Additional and/or other aspects and advantages of the inventive concept will be set forth in part in the description which follows and, in part, will be obvious from the description, or may be learned by practice of the inventive concept.

### BRIEF DESCRIPTION OF THE DRAWING FIGURES

The above and/or other aspects of the inventive concept will be more apparent by describing certain exemplary embodiments with reference to the accompanying drawings, in which:

FIG. 1 is a diagram of an external interface and a memory command scheduler structure according to an exemplary embodiment;

FIG. 2 is a view showing a first-ready first-come-first-served (FR-FCFS) scheduling example;

FIG. 3 is a view showing a motive of a future prediction technology according to an exemplary embodiment;

FIG. 4 is a mimetic diagram showing scheduling depending on the future prediction technology according to an exemplary embodiment;

FIG. 5 is a block diagram schematically showing a configuration of a memory command scheduler according to an exemplary embodiment;

FIGS. 6 and 7 are flow charts of a command scheduling method according to an exemplary embodiment; and

FIG. 8 is a graph showing a result obtained by using a memory command scheduling method according to an exemplary embodiment.

### DETAILED DESCRIPTION OF THE EXEMPLARY EMBODIMENTS

Hereinafter, various exemplary embodiments will be described in detail with reference to the accompanying drawings.

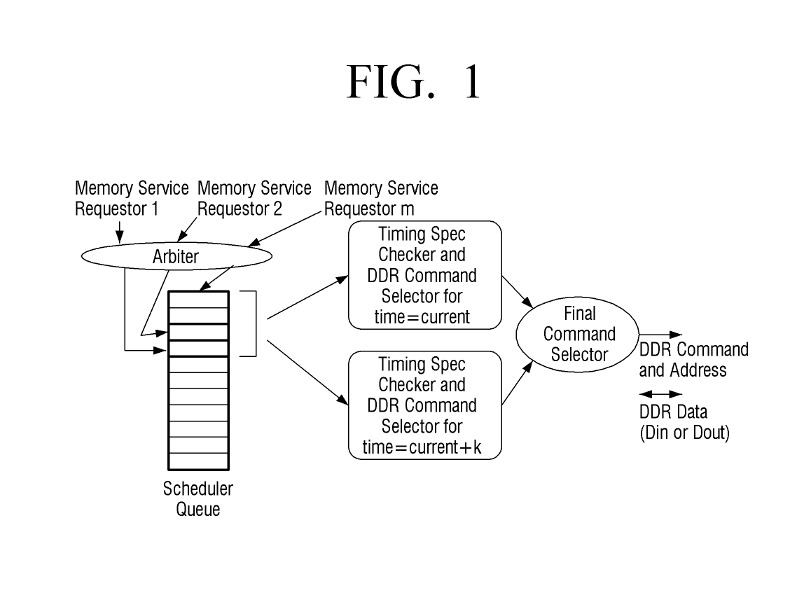

FIG. 1 is a diagram of an external interface and a memory command scheduler structure.

It is assumed that an m external devices may make a memory read or write request (where, m indicates an integer), and an arbitrating apparatus in a simple round robin or at least recently used scheme may be used. Even though a request for different data sizes is received, the requested data size is converted into a block unit. One block includes a plurality of bytes sent to a target DDRx SDRAM chip through a data bus interface within 8 bursts (4 clock cycles). Two entries are selected in a scheduler queue during each clock cycle. A first entry, which corresponds to an entry to be currently executed, is determined based on a current bank state, a parameter for the entry, and a latency time interval limit between several DDR commands specified in a DDRx specification.

Using the same heuristic determination, an optimal command to be executed is selected as a second entry when a current time is a time elapsed by K clock cycles. This is selection based on a future prediction. Finally, a current optimal entry or a future optimal entry is selected, and a current DDR command for the selected entry is sent to an external DDRx SDRAM chip.

In FIG. 1, a modification for a DDR command, a first-ready first-come-first-served (FR-FCFS) heuristic, and a future prediction feature from memory read/write requests are shown as a series of examples. In these examples, timing parameter values for a DDR4-2400P memory chip, which is a typical version of a DDR4 SDRAM device, are used. The following Table 1 shows some of the timing parameter values.

TABLE 1
Selected Parameter Values for DDR4-2400P Memory Chip.

| Parameter | Value (units)* | |
|---|---|---|
| Clock frequency | 1200 | (MHz) |
| Data bus width (size of one word) | 16 | (bits) |
| Data burst length (for one R/W command) | 8 | |
| Total number of memory banks | 16 | |
| Total number of memory bank groups | 2 | |
| Size of one page of data (row size) | 2 | (Kbytes) |
| tRP: minimum P to A delay | 15 | (cc) |
| tRCD: minimum A to R/W delay | 15 | (cc) |
| tRAS: minimum A to P delay | 39 | (cc) |
| tCL (CAS latency): R to returned data burst | 15 | (cc) |
| tCWL (CAS write latency): W to data burst | 12 | (cc) |
| tCCD_L: R/W to R/W, same bank group (B.G.) | 6 | (cc) |
| tCCD_S: R/W to R/W, different bank group (B.G.) | 4 | (cc) |
| tRTP: minimum R to P delay | 9 | (cc) |
| tWR: minimum end-of-data to P delay | 18 | (cc) |
| tRtoW: minimum R to W delay | 10 | (cc) |
| tWTR_L: minimum end-of-data to R, same B.G. | 9 | (cc) |
| tWTR_S: minimum end-of-data to R, diff. B.G. | 3 | (cc) |

*Note:
cc = clock cycles

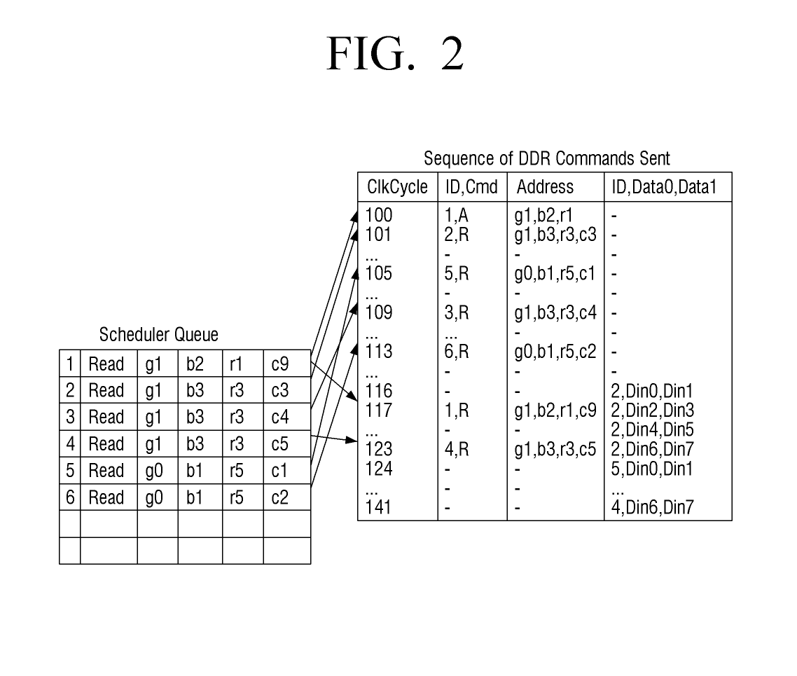

FIGS. 2 to 4 show examples of a method in which a memory service request is translated into a sequence of DDR commands.

FIG. 2 is a view showing an FR-FCFS scheduling example for a sequence of 6 read requests.

In FIG. 2, if a request having the lowest ID is the oldest request, it becomes a first request that is scheduled. In this case, a memory bank having a bank in a bank group 1 is first closed, and a corresponding DDR command is activated (which is to open one row and cache data on the row present in a row buffer).

A second request present in a scheduler queue is performed together with a read command (R) in a clock cycle (CC) 101. It is assumed that a corresponding bank (i.e., bank 3) is in a state in which a row buffer has requested row data and the bank is already opened. In this case, a request for the next ID=5 is selected in a clock cycle (CC) 105, since 4 clock cycles are required before the next read command (R) for other bank groups may be sent according to a tCCD_S parameter of the Table 1.

As this scheme is continued, a read command is sent until a clock cycle (CC) 123 and a final data word returns in a clock cycle (CC) 141 (See a timing specification of the Table 1). Eight data burst words return in 4 clock cycles with respect to each read command, since a device is a double data rate device. It may be appreciated that the read command is sent in the clock cycle (CC) 101 and a read command of ID=5 is sent in the clock cycle (CC) 105 positioned after 4 clock cycles from the CC 101. Command execution starts after a corresponding R command in a tCL=15 clock cycle. Therefore, data read is performed in a clock cycle (CC) 116 positioned after 15 clock cycles from the CC 101.

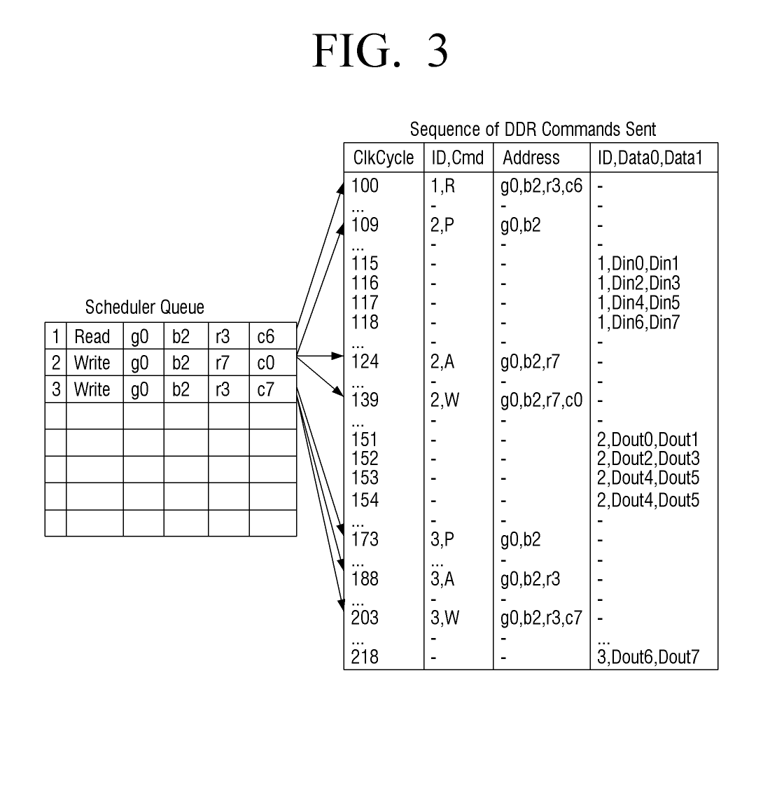

FIG. 3 is a view showing a motive of a future prediction technology according to an exemplary embodiment.

In FIG. 3, an FR-FCFS scheduling example for a sequence for one read request and two write requests following the one read request is shown. Since a requested row address is changed twice, this sequence of requests requires a long DDR command. In a clock cycle (CC) 109, a request of ID=2 is selected, and “P, g0, b2” (bank group 0, bank number 2) is selected, because a row buffer does not hold data in a row 7. A third queue entry may not be executed in the CC 109, because 10 clock cycles are required between a read command and a write command according to the Table 1. In addition, since the request of ID=2 is preferentially performed, a DDR command sequence for a request of ID=3 should start at “P, g0, b2”. The reason is that the row 7 is present in a current row buffer after the CC 109. Since 15 clock cycles are required between a precharge command and an activate command, an activate command for a request of ID=3 is performed in a CC 188. A sequence of all requests is completed in 218 clock cycles, because a write command is performed after 12 clock cycles from the activate command and requires 4 clock cycles.

However, since bank groups, banks, and row addresses of the request of ID=1 and the request of ID=3 coincide with each other, when the request of ID=2 is not present, the request of ID=3 may be more rapidly performed, because the precharge command and the activate command are not required in this case. When the request of ID=2 is not performed in the CC 109, the request of ID=3 will be performed as one write command in a CC 110.

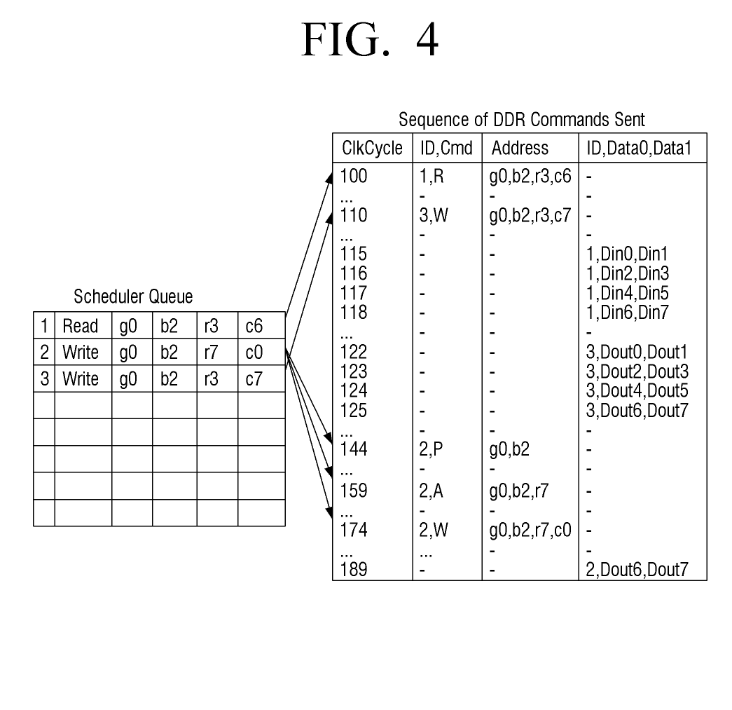

FIG. 4 is a mimetic diagram showing scheduling depending on the future prediction technology in which a sequence of commands required for a request is considered.

As shown in FIG. 4, a request of ID=2 is not performed and any other commands are not performed in a CC 109, and a request of ID=3 is processed in a CC 110 after waiting one clock cycle. Since a bank group, a bank, and a row address of the request of ID=3 coincide with those of a request of ID=1, precharge command and activate command are not performed, and a write command is directly read. Since a write command is performed after 12 clock cycles from the activate command and requires 4 clock cycles, write is substantially performed from a CC 122 to a CC 125. After the request of ID=3 is performed, the request of ID=2 is performed. Due to this simple change, a sequence of all requests may be completed in 189 clock cycles, because it is determined that a P command prepared in the CC 109 is postponed in order to perform a more preferable write command in the CC 110 using the structure of FIG. 1 when k=1.

The future prediction method described above is combined with a light-handed priority handling scheme, thereby making it possible to provide a higher quality of service (QoS) with respect to a request device or a memory request. Therefore, it is secured to maintain an entire memory throughput in the same level and allow an excessive performance disadvantage not to be imposed to another device making a request while decreasing an average latency for a request from a selected device. If a simple scheme is used, requests having low priorities are not operated until requests having high priorities are completed.

In a suggested QoS mechanism, a waiting time threshold which is defined as an urgency threshold for each request having a high priority is used. If a memory request requiring a QoS waits in a scheduler queue during clock cycles corresponding to the number coinciding with the urgency threshold, the memory request is called an urgent request. All urgent requests are positioned in a head of the scheduler queue. That is, the urgent requests are considered as the oldest request. In addition, if a selection is present between a current command and a future command in the scheduler structure of FIG. 1, a priority is given to the urgent request as compared with a non-urgent request. The above two types of requests are in an execution-ready state. In the case of an urgent future request, it is not allowed that a non-urgent current execution-ready request hinders execution of the urgent future request. This example corresponds to the case in which two accesses have different row addresses and the same bank. A detailed operation of the QoS mechanism may be described using the following pseudo code.

Pseudo code Description:

| | |
|---|---|
| 1. | Look at each entry of the scheduler queue in order starting from |

the oldest entry to the newest entry //compare entries of the scheduler
queue with each other in order to first execute the oldest entry

| | |
|---|---|
| 2. | Find the following scheduler queue entries: |

2a. E0 = earliest urgent entry with ready DDR command.
2b. E1 = earliest entry with DDR command = R or W.
2c. E2 = earliest future (k CC later) urgent entry with DDR command = R,
W, P or A.
2d. E3 = earliest entry with DDR command = P or A.
2e. E4 = earliest future (k CC later) urgent entry with DDR command = R
or W.

| | |
|---|---|
| 3. | The scheduler queue entry E is selected using the following |

checks:
If E0 exists, then E = E0;
Else if E1 exists, then
If E2 exists, the DDR command = R or W, and E2 uses the same bank and
row as those of E1,

then E = E2; // i.e., wait until E2 is executed
Else E = E1;

Else if E3 exists, then
If E2 exists and uses the same bank and row as those of E3, then

E = E2; // i.e., wait until E2 is executed
Else E = E3;

Else if E4 exists, then E = E4.
Send the DDR command and address for entry E.
Remove the entry E (if it exists) from the scheduler queue.

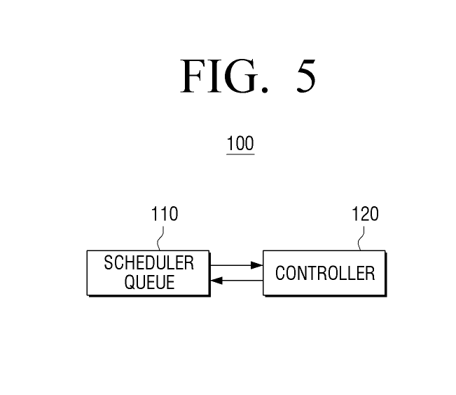

FIG. 5 is a block diagram schematically showing a configuration of a memory command scheduler according to an exemplary embodiment performing the above-mentioned pseudo code.

Referring to FIG. 5, the memory command scheduler 100 is configured to include a scheduler queue 110 and a controller 120.

The scheduler queue 110 is configured to receive requests for a memory access from external devices and store the received requests therein. Here, the external devices may be various peripheral devices of a computer system. The request is to demand to issue a command for reading data from a specific position of a memory or writing data to the specific position of the memory. The request includes a bank, a bank group, a row address, and a column address of the memory. The controller 120 processes the request to issue an access command to a preset position on the memory.

The controller 120 controls memory command scheduling. That is, the controller 120 performs an operation of a row buffer (not shown), authorization of data bus occupation, control command transmission, clock signal generation, or the like. In particular, the controller 120 determines an order of requests to be processed on the scheduler queue 110 and processes the requests according to the determined order.

The controller 120 processes the requests in an order in which the requests are input to the scheduler queue 110. However, in order to address a problem occurring when the requests are processed in the order in which the requests are input to the scheduler queue 110, the scheduling technology described above is used. Consider the case in which generation of a read or write command of a first request is possible in a current clock cycle and generation of a read or write command of a second request is possible after a preset number of clock cycles from the current clock cycle. In this case, the controller 120 does not generate the read or write command of the first request in the current clock cycle, but waits until the preset number of clock cycles elapse. When the preset number of clock cycles elapse, the controller 120 generates the read or write command of the second request and transfers the generated command to the memory. As in an exemplary embodiment of FIG. 4, the request of ID=2 is not processed in the CC 109, and the request of ID=3 is first processed in the CC 110 after waiting one clock cycle.

However, if generation of the read or write command of the first request is possible in the current clock cycle, but generation of the read or write command of the second request is not possible after the preset number of clock cycles from the current clock cycle, the controller 120 does not need to wait the preset number of clock cycles, and generates the read or write command of the first request in the current clock cycle and transfers the generated command to the memory.

However, if a third request for a memory access that should be urgently executed in the current clock cycle is received and stored in the scheduler queue 110, the controller 120 may preferentially process the third request. In this case, the third request has the highest priority. That is, the controller 120 generates a control command of the third request so as to be more preferential than the first and second requests and transfers the generated control command to the memory.

Hereinafter, a command scheduling method according to various exemplary embodiments will be described.

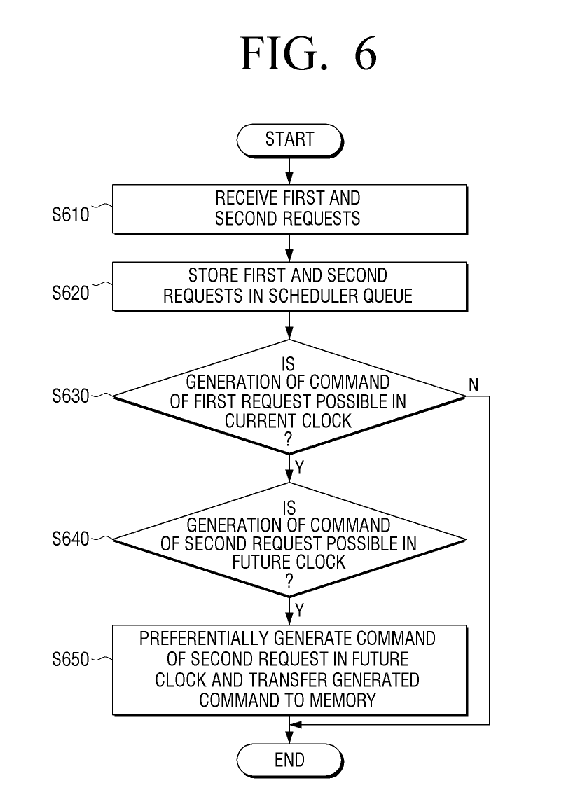

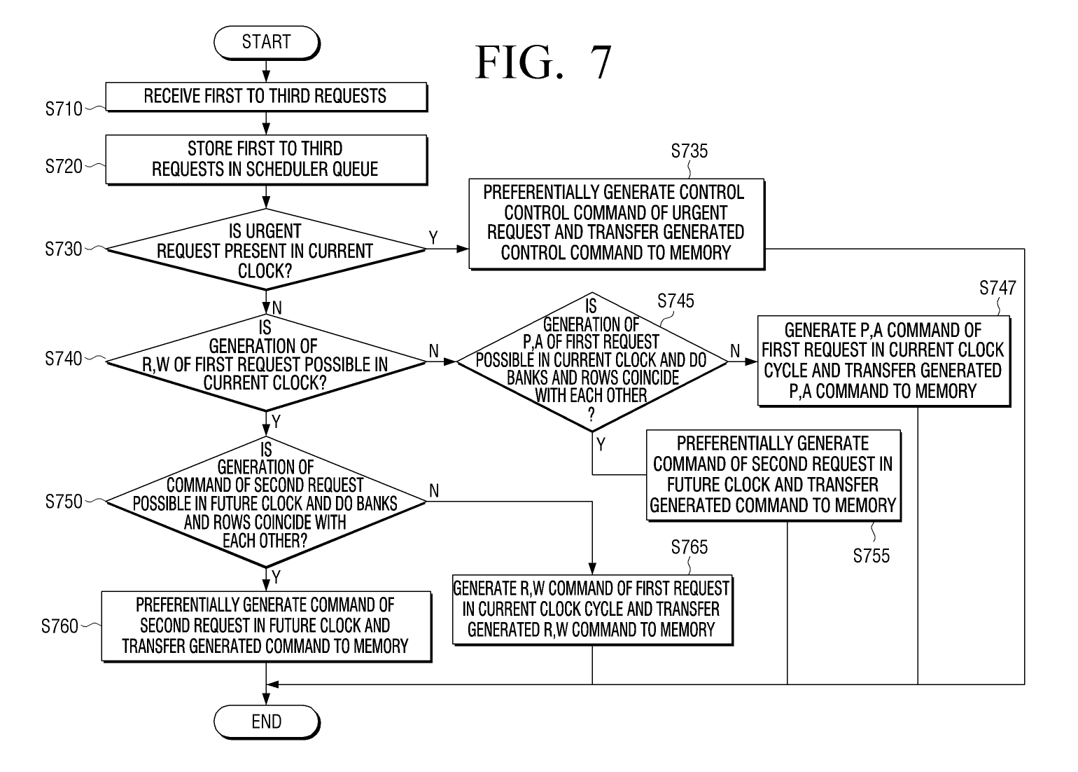

FIGS. 6 and 7 are flow charts of a command scheduling method according to an exemplary embodiment.

Referring to FIG. 6, the command scheduling method according to an exemplary embodiment includes receiving first and second requests for a memory access (operation S610), storing the first and second requests in the scheduler queue (operation S620), preferentially generating a command of the second request after a preset number of clock cycles, and transferring the generated command to the memory (operation S650) (without generating a read or write command of the first request in a current clock cycle) if generation of a command of the first request is possible in the current clock cycle (operation S630—Y) and generation of the command of the second request is possible after the preset number of clock cycles from the current clock cycle (operation S640—Y).

As soon as the first and second requests are input, and as long as a buffer has an empty space, the first and second requests are accommodated in the empty space of the buffer and are stored in the scheduler queue. The scheduler queue is searched in each clock cycle to select the oldest request (first request) ready to be executed in the current clock cycle and the oldest request (second request) ready to be executed after k clock cycles. Then, an actual command sent to the memory in the current clock cycle is a command of the first request or the second request. Here, when the first request does not hinder the second request from being executed after the k clock cycles or the second request has a priority higher than that of the first request, the command of the first request is finally selected. On the other hand, when hindrance between the first and second requests may be present and the second request has a priority higher than that of the first request, the second request is finally selected. When the first request is finally selected, the command of the first request is directly sent to the memory. However, when the second request is finally selected, the command of the second request may be sent after the k clock cycles. Therefore, any command is not sent to the memory in the current clock cycle.

Referring to FIG. 7, the command scheduling method according to another exemplary embodiment includes receiving first to third requests for a memory access (operation S710), storing the first to third requests in the scheduler queue (operation S720), preferentially generating a control command of an urgent request, and transferring the control command to the memory (operation 5735) if a request that is to be urgently processed in a current clock is present (operation S730—Y).

If the urgent request has been already processed or is not present, it is decided whether generation of read R or write W of the first request is possible. That is, it is decided whether a memory bank is in an open state.

When generation of a read or write command of the first request is possible in the current clock cycle, the read or write command of the first request may be generated in the current clock cycle regardless of a command depending on the second request and be transferred to the memory, because the read or write command should be processed more preferentially as compared with other commands in order to improve memory throughput performance.

When generation of the read or write of the first request is not possible in the current clock cycle (operation S740—N), it is decided whether the memory bank should be opened (operation S745). If generation of precharge or activate is possible and memory banks or row addresses of the first and second requests are the same as each other (operation S745—Y), the command of the second request is preferentially generated after a preset number of clock cycles and is transferred to the memory (operation S755). However, if the memory banks or the row addresses of the first and second requests are different from each other (operation S745—N), precharge or activate command of the first request is generated in the current clock cycle and is transferred to the memory (operation S747).

If generation of the read or write of the first request is not possible in the current clock cycle (operation S740—N), it is decided whether generation of the command of the second request is possible in a clock cycle (future clock) after preset clock cycles and it is decided whether the memory banks or the row addresses of the first and second requests coincide with each other (operation S750). If the memory banks or the row addresses of the first and second requests coincide with each other (operation S750—Y), the command of the second request is preferentially generated in the future clock cycle after waiting the set clock cycles, and is transferred to the memory without performing the read or write command of the first request in the current clock cycle (operation S760).

In this case, when the command of the first request is executed, the command of the second request will not be executed any more after the k clock cycles. Therefore, in order to execute the command of the second request without sending the command of the first request to the memory, it is required that any command is not sent to the memory.

However, when the execution of the command of the second request is not possible (operation S750—N), the read or write command of the first request is generated in the current clock cycle and is transferred to the memory (operation S765).

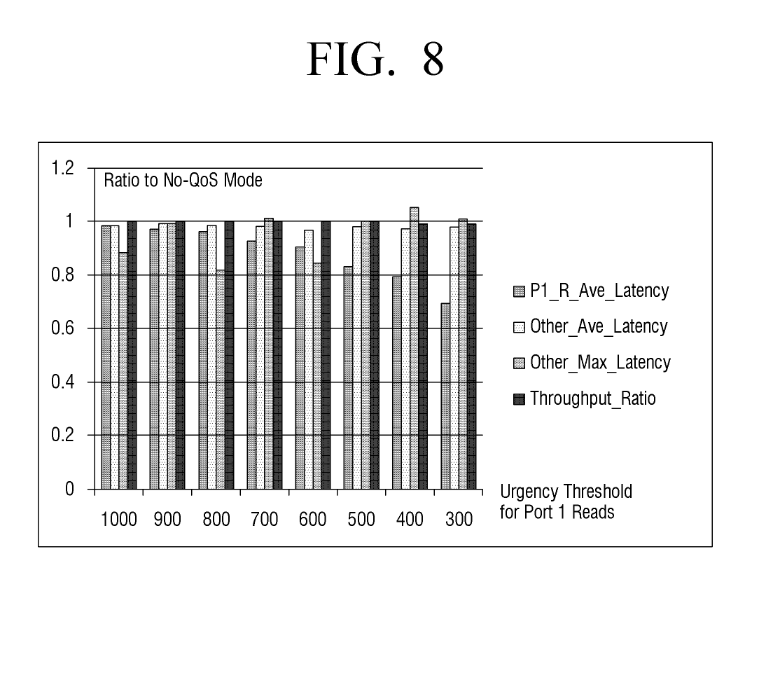

FIG. 8 is a graph showing a result obtained by using a memory command scheduling method according to an exemplary embodiment.

In this example, three request device sets generating memory requests at a high speed are given (they have memory address values obtained from a substantial hardware device memory log). The example shown in FIG. 8 has been simulated using the suggested scheduler structure having approximately seven million clock cycles and the method thereof. Simulation results have been first obtained from devices that do not have priorities. Then, read requests from one of the devices were labeled by P1 and were designated as a priority request. An average read latency of the P1 requests was continuously decreased from 98% of an original value to 70% as a result of a decrease of an urgency threshold. At the same time, an entire memory throughput was maintained as a value that is approximately the same as an original value, and average and maximum delays of requests from other devices were 85% to 105% of original values.

Meanwhile, the memory scheduling method described above may be stored in a program form in a computer-readable non-temporal recording medium. Here, the computer-readable non-temporal recording medium means a medium capable of semi-permanently storing data therein and being read by an electronic apparatus. In addition, the memory scheduling method described above may be embedded and provided in a hardware integrated circuit (IC) chip in an embedded software form.

The present disclosure provides an efficient memory command scheduling method and structure using future prediction based on information present in a scheduler queue and an innovative memory command scheduler and memory command scheduling method capable of maintaining memory throughput levels and decreasing memory latencies while preferentially processing high priority requests.

According to an aspect of exemplary embodiments, there is provided a memory command scheduler with a scheduler queue configured to receive sequences of memory read and write requests from a finite set of external devices. These requests are transferred to a single scheduler queue or multiple scheduler queues, with one scheduler queue for each bank, in first-come-first-served order, provided that space is available for the new requests in the scheduler queue. Concurrently, at each clock cycle, the entire contents of the scheduler are searched in order from the oldest to the youngest requests. Based on the inter-command timing rules specified by the timing specifications for the specific DDRx memory chips being used, those requests for which memory commands (one of precharge, activate, read, or write commands) can be sent during the current clock cycle are identified. The first high priority request for which any memory command can be sent during the current clock cycle is identified as E1. The first request for which a read or write command can be sent during the current clock cycle is identified as E2. The first request for which a precharge or activate command can be sent during the current clock cycle is identified as E3.

A search is also conducted for a desirable future command. This search is conducted assuming that the current time is NOT the current clock cycle but a preset number of clock cycles after the current clock cycle. The first request for which a read or write command can be sent after the preset number of clock cycles is identified as E4.

After determining the first desirable high priority request E1, the first desirable read/write request E2, the first desirable precharge/activate request E3, and the first desirable future request E4, the scheduler queue request to process during the current clock cycle is selected from among E1, E2, E3, and E4 based on heuristics for increasing the total memory throughput and prioritizing high priority memory requests. Then the memory command for the selected scheduler entry is sent to the targeted DDRx SDRAM memory device.

The commands of the E1, E2, E3, and E4 requests may have the same memory bank and row address.

The controller may generate the command for the E1, E2, or E3 request in the current clock cycle and transfer the generated command to the memory if the targeted memory bank can accept that command based on its current state, the contents of its row buffer, and timing restrictions between that command and previous memory commands as stated in the timing specifications for the targeted memory device.

Even if a ready E1, E2, or E3 request exists in the scheduler queue, the controller may simply not send a memory command if it is determined that it is better to wait and send a memory command for the E4 request several clock cycles in the future

The controller may generate a precharge or activate command for the E3 request and transfer the generated precharge or activate command to the memory, if generation of a read or write command for an E1 request is not possible in the current clock cycle.

The read or write command may be transferred together with an address for the memory to the memory.

Memory command scheduling may be performed based on an order in which the requests are received.

The memory may be a double data rate (DDR) synchronous dynamic random access memory (SDRAM).

The memory command scheduler may further include a row buffer configured to store data on a preset bank and row address of the memory therein if an activate command of a request for a memory access from the external devices is present.

The memory command scheduling method may further include generating a read or write command for a request in the scheduler queue after a preset number of clock cycles from the current clock cycle and transferring the generated command to the memory, if it is determined that an urgent request cannot be processed in the current clock cycle, generation of a read or write command is not possible in the current clock cycle and generation of a read or write command after the preset number of clock cycles from the current clock cycle.

The memory command scheduling method may further include generating a precharge or activate command in the current clock cycle and transferring the generated precharge or activate command to the memory, if it is determined that an urgent request cannot be processed in the current clock cycle, generation of a read or write command is not possible in the current clock cycle, and generation of a read or write command, for the same bank as the bank targeted by the ready precharge or activate command, after the preset number of clock cycles from the current clock cycle is not possible.

As set forth above, according to exemplary embodiments, an innovative memory command scheduler and memory command scheduling method capable of maintaining a memory throughput and decreasing average and maximum memory request latency times while preferentially processing a request having a high priority by performing future prediction based on information present in a memory command scheduler queue are provided.

Although exemplary embodiments have been disclosed for illustrative purposes, those skilled in the art will appreciate that various modifications, additions and substitutions are possible, without departing from the scope and spirit of the inventive concept as disclosed in the accompanying claims.

What is claimed is:

1. A memory command scheduler comprising:
a scheduler queue configured to receive first and second requests for a memory access from external devices and store the first and second requests therein; and
a controller configured to generate a command of the second request after a preset number of clock cycles from a current clock cycle and transfer the generated command to a memory, if generation of a command of the first request is possible in the current clock cycle and generation of a command of the second request is possible after the preset number of clock cycles from the current clock cycle.

2. The memory command scheduler as claimed in claim 1, wherein the commands of the first and second requests have the same memory bank and row address.

3. The memory command scheduler as claimed in claim 1, wherein the controller is configured to generate the command of the first request in the current clock cycle and transfer the generated command to the memory, if memory banks or row addresses of the commands of the first and second requests are different from each other.

4. The memory command scheduler as claimed in claim 1, wherein the controller is configured to generate a control command of a third request so as to be more preferential than the first and second requests and transfer the generated control command to the memory, if the third request for a memory access that is to be urgently executed in the current clock cycle is received and stored in the scheduler queue.

5. The memory command scheduler as claimed in claim 1, wherein the controller is configured to generate a precharge or activate command of the first request and transfer the generated precharge or activate command to the memory, if generation of a read or write command of the first request is not possible in the current clock cycle.

6. The memory command scheduler as claimed in claim 1, wherein the generated command is transferred together with an address for the memory to the memory.

7. The memory command scheduler as claimed in claim 1, wherein a memory command scheduling is performed based on an order in which the requests are received.

8. The memory command scheduler as claimed in claim 1, wherein the memory is a double data rate (DDR) synchronous dynamic random access memory (SDRAM).

9. The memory command scheduler as claimed in claim 1, further comprising a row buffer configured to store data on a preset bank and row address of the memory therein if an activate command of a request for a memory access from the external devices is present.

10. A memory command scheduling method comprising:
receiving first and second requests for a memory access;
storing the first and second requests in a scheduler queue; and
generating a command of the second request after a preset number of clock cycles from a current clock cycle and transferring the generated command to a memory, if generation of a command of the first request is possible in the current clock cycle and generation of the command of the second request is possible after the preset number of clock cycles from the current clock cycle.

11. The memory command scheduling method as claimed in claim 10, wherein the commands of the first and second requests have same memory bank and row address.

12. The memory command scheduling method as claimed in claim 10, further comprising generating the command of the first request in the current clock cycle and transferring the generated command to the memory, if memory banks or row addresses of the commands of the first and second requests are different from each other.

13. The memory command scheduling method as claimed in claim 10, further comprising generating a control command of a third request so as to be more preferential than the first and second requests and transferring the generated control command to the memory, if the third request for a memory access that is to be urgently executed in the current clock cycle is received and stored in the scheduler queue.

14. The memory command scheduling method as claimed in claim 10, further comprising generating a precharge or activate command of the first request and transferring the generated precharge or activate command to the memory, if generation of a read or write command of the first request is not possible in the current clock cycle.

15. The memory command scheduling method as claimed in claim 10, wherein the generated command is transferred together with an address for the memory to the memory.

16. The memory command scheduling method as claimed in claim 10, wherein the memory command scheduling is performed based on an order in which the requests are received.

17. The memory command scheduling method as claimed in claim 10, wherein the memory is a DDR SDRAM.

18. A memory command scheduling method comprising:
receiving first to third requests for a memory access;
storing the first to third requests in a scheduler queue;
determining whether an urgent request is present in a current clock cycle; and
generating a control command of the urgent request in the current clock cycle and transferring the generated control command to a memory, if it is determined that the urgent request is present in the current clock cycle.

19. The memory command scheduling method as claimed in claim 18, further comprising generating a command of the second request after a preset number of clock cycles from the current clock cycle and transferring the generated command to the memory, if it is determined that the urgent request is not present in the current clock cycle, generation of a command of the first request is possible in the current clock cycle, and generation of the command of the second request is possible after the preset number of clock cycles from the current clock cycle.

20. The memory command scheduling method as claimed in claim 18, further comprising generating a command of the second request after a preset number of clock cycles from the current clock cycle and transferring the generated command to the memory, if it is determined that the urgent request is not present in the current clock cycle, generation of a read or write command of the first request is not possible in the current clock cycle, generation of a precharge or activate command of the first request is possible in the current clock cycle, and the commands of the first and second requests have same memory bank and row address.

21. The memory command scheduling method as claimed in claim 18, further comprising generating a precharge or activate command of the first request in the current clock cycle and transferring the generated precharge or activate command to the memory, if it is determined that the urgent request is not present in the current clock cycle, generation of a read or write command of the first request is not possible in the current clock cycle, generation of a precharge or activate command of the first request is possible in the current clock cycle, and memory banks or row addresses of the first and second requests are different from each other.

22. The memory command scheduling method as claimed in claim 18, further comprising generating a read or write command of the first request in the current clock cycle and transferring the generated read or write command to the memory, if it is determined that the urgent request is not present in the current clock cycle, generation of the read or write command of the first request is possible in the current clock cycle, and generation of a command of the second request is not possible after a preset number of clock cycles from the current clock cycle.
